(19) United States
(12) Patent Application Publication
(10) Pub. No.: US 2008/0223395 A1
(43) Pub. Date: Sep. 18, 2008

(54) Hair-Styling Foil and Method For Preparing Hair-Fixing Products in Foil Form

(76) Inventors: Sarah Maillefer, Middes (CH); Benedikt Zenhaeusern, Giffers (CH); Ute Doepner-Reichenbach, Koenigstein (DE); Monika Moenks, Schmitten (CH); Karin Steinbrecht, Ober-Ramstadt (DE)

Correspondence Address: MICHAEL J. STRIKER, 103 EAST NECK ROAD, HUNTINGTON, NY, 11743, US

(21) Appl. No.: 10/586,429

(22) PCT Filed: Jan. 11, 2005
(86) PCT No.: PCT/EP2005/000151

§ 371 Date: Mar. 17, 2008

(30) Foreign Application Priority Data
Jan. 21, 2004 (DE) 10 2004 002 951.2

(51) Int. Cl. A45D 19/18; B29C 39/00

(52) U.S. Cl. 132/270; 264/299

(57) ABSTRACT

A method for producing a hair-fixing product in the form of a foil is described whereby first a viscous, rollable composition is prepared by dissolving or dispersing a polymer in a liquid carrier medium and then the composition is shaped into a foil by rolling it with the aid of a rolling device and the liquid carrier medium is evaporated. Also described are hair-styling foils that contain at least one hair-fixing polymer and advantageously additional surfactants or polyols and that preferably are treated with an adhering, powdered, hydrophobic release agent.

The invention has for an object a method for preparing hair-fixing products in foil form as well as hair-treating agents for fixing hair in the form of a solid, water-soluble foil, particularly one based on pullulan and optionally on additional hair-fixing polymers.

To fix human hair and impart hold to it or to stabilize a completed hairdo, hair-treating agents are used which as a rule are in the form of gels, foams, sprays or lotions based on fluid solvents. The drawback of such solvent-based products is that because of the high solvent and/or propellant content, they are voluminous and heavy and, hence, are not well suited for being carried along by a person. This problem is normally solved by packing the products into very small containers. Such products have the drawback that they are sufficient for only very few applications. Moreover, it is not possible to package them as early as at the time of their preparation as solid, discrete pieces sufficient for an application. Spatial shaping and the preparation of attractive external forms are also not possible. Moreover, low-viscosity gels or thixotropic gels capable of liquefying under pressure can flow off the hands or hair during use.

JP 01-131109 discloses hair-treating agents in the form of sheets or plates which are prepared by casting a solution into molds and evaporating the solvent. Such sheets or plates are still not entirely satisfactory, particularly as regards surface uniformity, product thickness and related application properties, for example the dissolution rate during use.

From EP 1 137 916 are known films containing pullulan or modified starch and which are prepared via breakdown of the starch of certain starch derivatives and by drawing a film using the knife-over-roll coating method and overnight conditioning. Although the described films are soluble in glass containing 37° C. water, the dissolution performance relevant for uses as a hair styling foil on moist hands or moist hair is not satisfactory. The knife-over-roll coating method as a rule allows only the preparation of coatings that are 0.5 mm thick. Typical attainable coating thicknesses are 1 to 30 mm. Films having such a thickness do not exhibit satisfactory dissolution characteristics for use as hair-styling foils.

The purpose of the invention was to provide essentially solvent-free foils which upon contact with moisture, namely with a relatively small amount of water, could readily be made to dissolve by rubbing them with the hands and which after having been worked into the hair would exert a hair-fixing action and permit the shaping of the hair into a hairdo. Rubbing was not supposed to leave behind softened, undissolved foil particles which during styling of the hairdo could lead to undesirable visible or perceivable residues on the head.

The foils were to be stackable and/or so flexible that they could be rolled up. They were to be resistant to air humidity to an extent such that upon direct contact with one another they would not stick together and even upon extended storage would readily be detached from one another.

The invention has for an object a method for preparing a hair-fixing product in the form of a foil by
first preparing a rollable composition by dissolving or dispersing a polymer in a liquid carrier medium, then
shaping the composition into a foil by means of a rolling device and
at the same time or subsequently evaporating the liquid carrier medium.

The invention also has for an object hair-styling foils, particularly hair-styling foils prepared according to the invention, and the use of said foils for hair fixing.

The rollable composition can have a semisolid, doughy consistency or it can consist of a viscous liquid used to coat an appropriate carrier the desired foil thickness being obtained by rolling on a rolling device. After drying, the finished foil is removed from the carrier.

Suitable carrier materials are, for example, silicones, metals, metallized polymers, polytetrafluoroethylene, polyether/polyamide block copolymers, polyurethanes, polyvinyl chloride, nylon, alkylene/styrene copolymers, polyethylene, polyesters or other detachable materials. Suitable rolling devices are, in particular, those known to persons skilled in the art of coating and painting technology and which are provided with at least two drums or rollers moving in the opposite direction and known as the forward-roll or reverse-roll coaters of which the reverse-roll method is preferred.

A foil in the sense of the invention is a solid, essentially solvent-free product of planar, flat geometry and having a thickness that is preferably less than or equal to 1 mm and particularly less than 0.5 mm, for example from 0.05 mm to less than 0.5 mm. The residual solvent content is preferably less than 5 wt. % and particularly less than 1 wt. %.

### Polymers

Suitable polymers include those that by themselves already exhibit foil-forming and/or hair-fixing properties. It is also possible, however, to use mixtures of polymers so that after evaporation of the solvent the mixture exhibits foil-forming and/or hair-fixing properties. The polymer content of the rollable composition can range from 10 to 80 wt. %, from 20 to 70 wt. % or from 30 to 60 wt. %. After evaporation of the liquid carrier medium, the polymer content of the finished foil can range from 50 to 97 wt. %, from 60 to 95 wt. % or from 80 to 95 wt. %, a content greater than or equal to 85 wt. % being particularly preferred.

Preferably, at least one of the polymers used is water-soluble. Pullulan is particularly preferred. A suitable pullulan can have an average molecular weight Mr of 10,000 to 5,000,000. Preferably, the composition contains at least one hair-fixing polymer and particularly a combination of pullulan and at least one hair-fixing polymer. The weight ratio of pullulan to the additional, hair-fixing polymer can range from 1:10 to 10:1 and particularly from 1:5 to 5:1 or from 1:2 to 2:1. The ratio is preferably less than 2:1 and most preferably less than 1:1, for example from 1:2 to less than 1:1.

The hair-fixing polymer can be selected from among anionic, cationic, zwitterionic, nonionic and amphoteric polymers. The polymer can be natural or synthetic. By synthetic polymers are meant polymers which are entirely synthetic and not of natural origin, in particular polymers that can be prepared by free radical-initiated polymerization of ethylenically unsaturated monomers or by polycondensation. By natural polymers are meant polymers of natural origin which subsequently may have been modified chemically or physically. Preferred in particular, however, are polymers that have adequate solubility or dispersibility in the carrier medium, particularly in water, alcohol or water/alcohol mixtures so that in the carrier medium they are present in dissolved or uniformly dispersed form. By hair-fixing polymers are meant according to the invention polymers which when applied as a 0.01 to 5% aqueous, alcoholic or aqueous-alcoholic solution or dispersion are capable of depositing a polymer film on the hair thus fixing the hair.

Suitable nonionic polymers are homopolymers or copolymers derived from at least one of the following monomers: vinyllactams, particularly vinyl pyrrolidone and vinyl caprolactam, vinyl esters, for example vinyl acetate, vinyl alcohols, acrylamides, methacrylamides, alkyl acrylamides, dialkylacrylamides, alkylmethacrylamides, dialkylmethacrylamides, dialkylaminoalkylmethacrylamides, dialkylaminoalkylacrylamides, alkyl acrylates, alkyl methacrylates, propylene glycol and ethylene glycol, the alkyl groups of these monomers preferably being C₁ to C₇ alkyl groups and particularly C₁ to C₃ alkyl groups. Suitable are, for example, the homopolymers of vinylcaprolactam, of vinylpyrrolidone and of N-vinylformamide. Other suitable synthetic film-forming, nonionic, hair-fixing polymers are, for example, the copolymers of vinylpyrrolidone and vinyl acetate, the terpolymers of vinylpyrrolidone, vinyl acetate and vinyl propionate and furthermore polyacrylamides, polyvinyl alcohols and polyethylene glycol/polypropylene glycol copolymers. Particularly preferred are polyvinylpyrrolidone, polyvinylcaprolactam and the copolymers thereof with at least one other nonionic monomer, particularly polyvinylpyrrolidone/vinyl acetate copolymers.

Suitable anionic hair-fixing polymers are, for example, synthetic homopolymers and copolymers comprising acid groups-containing monomer units, optionally copolymerized with comonomers devoid of acid groups. The acid groups are preferably selected from among —COOH, —SO₃H, —OSO₃H, —OPO₂H and —OPO₃H₂ among which the carboxyl group is preferred. The acid groups can be unneutralized, partly neutralized or completely neutralized. They are preferably 50 to 100% in anionic or neutralized form. Appropriate neutralizing agents are organic and inorganic bases suitable for cosmetic purposes. Examples of such bases are aminoalcohols, for example aminomethylpropanol (AMP), triethanolamine, monoethanolamine, tetrahydroxypropylethylenediamine, ammonia, NaOH and others. Suitable monomers are unsaturated, free radical-polymerizable compounds with at least one acid group, particularly carboxyvinyl monomers. Suitable acid groups-containing monomers are, for example, acrylic acid, methacrylic acid, crotonic acid, maleic acid or maleic anhydride and the monoesters thereof.

Comonomers not substituted with acid groups are, for example, acrylamide, methacrylamide, alkylacrylamide, dialkylacrylamide, alkylmethacrylamide, dialkylmethacrylamide, alkyl acrylate, alkyl methacrylate, vinylcaprolactone, vinylpyrrolidone, vinyl esters, vinyl alcohol, propylene glycol, ethylene glycol, amino-substituted vinyl monomers, for example dialkylaminoalkyl acrylate, dialkylaminoalkyl methacrylate, monoalkylaminoalkyl acrylate and monoalkylaminoalkyl methacrylate, the alkyl groups of these monomers preferably being C₁ to C₇ alkyl groups and particularly C₁ to C₃ alkyl groups.

Suitable anionic polymers are, in particular, the copolymers of acrylic acid or methacrylic acid with monomers selected from among acrylate or methacrylate esters, acrylamides, methacrylamides and vinylpyrrolidone, homopolymers of crotonic acid and copolymers of crotonic acid with monomers selected from among vinyl esters, esters of acrylic acid or methacrylic acid, acrylamides and methacrylamides. A suitable natural polymer is, for example, shellac. Preferred anionic polymers are the crosslinked and uncrosslinked vinyl acetate/crotonic acid copolymers. Also preferred are the partly esterified copolymers of vinyl methyl ether and maleic anhydride. Other preferred anionic polymers are, for example, the terpolymers of acrylic acid, alkyl acrylate and N-alkylacrylamide and particularly the terpolymers of acrylic acid/ethyl acrylate/N-tert. butylacrylamide and the terpolymers of vinyl acetate, crotonate and vinyl alkanoate, particularly vinyl acetate/crotonate/vinylneodecanoate copolymers; the copolymers of acrylic acid or methacrylic acid and alkyl acrylate or alkyl-methacrylate esters, the alkyl groups preferably containing 1 to 7 carbon atoms, and polystyrenesulfonates

Suitable hair-fixing amphoteric or zwitterionic polymers are polymers which besides acid or anionic groups contain as additional functional groups basic or cationic groups, particularly primary, secondary, tertiary or quaternary amino groups. Zwitterionic polymers are polymers derived from at least one kind of monomer containing both quaternary amino groups and acid groups, or polymers derived from at least one first kind of monomer containing quaternary amino groups and at least of one second kind of monomer containing acid groups. Amphoteric polymers are derived, for example, from at least one kind of monomer containing acid groups and at least one other kind of monomer containing basic amino groups. Examples of these are the copolymers derived from alkylacrylamide (particularly octylacrylamide), alkylaminoalkyl methacrylate (particularly tert.butylaminoethyl methacrylate) and two or more monomers selected from among acrylic acid, methacrylic acid and the C₁ to C₄ alkyl esters thereof, among which at least one of the monomers has an acid group, examples being the products available under the tradenames Amphomer® or Amphomer® LV-71.

Other suitable polymers are the copolymers of acrylic acid, methyl acrylate and methacrylamidopropyltrimethylammonium chloride (INCI designation: Polyquaternium-47), the copolymers of acrylamidopropyltrimethylammonium chloride and acrylates, and the copolymers of acrylamide, acrylamidopropyltrimethylammonium chloride, 2-amidopropylacrylamide sulfonate and dimethylaminopropylamine (INCI designation: Polyquaternium-43). Also suitable are polymers containing a betaine group, for example the copolymers of methacryloylethyllbetaine and two or more monomers of acrylic acid or the simple esters thereof, known under the INCI designation Methacryloyl Ethyl Betaines/Acrylates Copolymer.

Suitable cationic polymers preferably contain quaternary amino groups. The cationic polymers can be homopolymers or copolymers, with the quaternary nitrogen groups being located either in the polymer chain or preferably as a substituent in one or more of the monomers. The monomers containing ammonium groups may be copolymerized with noncationic monomers. Suitable cationic monomers are the unsaturated, free radical-polymerizable compounds containing at least one cationic group, particularly the ammonium-substituted vinyl monomers, for example trialkylmethacryloxyalkylammonium, trialkylacryloxyalkylammonium, dialkyldiallylammonium and quaternary vinylammonium monomers with groups containing cyclic cationic nitrogen such as pyridinium, imidazolium and quaternary pyrrolidones, for example alkylvinylimidazolium and alkylvinylpyridinium, or alkylvinylpyrrolidone salts. The alkyl groups of these monomers are preferably the lower alkyl groups, for example C₁ to C₇ alkyl groups and most preferably C₁ to C₃ alkyl groups. The monomers containing ammonium groups may be copolymerized with noncationic monomers. Suitable comonomers are, for example, acrylamide, methacrylamide, alkylacrylamide, dialkylacrylamide, alkyl methacrylamide, dialkylmethacrylamide, alkyl acrylate, alkyl methacrylate, vinylcaprolactone, vinylcaprolactam, vinylpyrrolidone, vinyl esters, for example vinyl acetate, vinyl alcohol, propylene glycol and ethylene glycol, the alkyl groups of these monomers preferably being C₁ to C₇ or C₁ to C₃ alkyl groups.

Cationic polymers with quaternary amino groups are, for example, the polymers described in the CTFA Cosmetic Ingredient Dictionary under the designation Polyquaternium, for example methylvinylimidazolium chloride/vinylpyrrolidone copolymer (Polyquaternium-16) or the quaternized vinylpyrrolidone/dimethylaminoethyl methacrylate copolymer (Polyquaternium-11) as well as the quaternary silicone polymers and oligomers, for example the silicone polymers with quaternary end groups (Quaternium-80). Suitable among the cationic polymers is, for example, the vinylpyrrolidone/dimethylaminoethyl methacrylate methosulfate copolymer sold under the tradenames Gafquat® 755 N and Gafquat® 734. Other cationic polymers are, for example, the copolymer of polyvinylpyrrolidone and imidazolimine methochloride sold under the tradename LUVIQUAT® HM 550, the terpolymer of dimethyldiallylammonium chloride, sodium acrylate and acrylamide sold under the tradename Merquat® Plus 3300, the terpolymer of vinylpyrrolidone, dimethylaminoethyl methacrylate and vinylcaprolactam sold under the tradename Gaffix® VC 713 and the vinylpyrrolidone/methacrylamidopropyltrimethylammonium chloride copolymer sold under the tradename Gafquat® HS 100.

Suitable cationic polymers derived from natural polymers are the cationic derivatives of polysaccharides, for example the cationic derivatives of cellulose, starch or guar. Also suitable are chitosan and chitosan derivatives. The cationic polysaccharides have the general formula

G—O—B—N⁺R¹R²R³X⁻

wherein
G denotes an anhydroglucose group, for example a starch anhydroglucose or cellulose anhydroglucose group;
B is a divalent connecting group, for example alkylene, oxyalkylene, polyoxyalkylene or hydroxyalkylene;
R¹, R² and R³ independently of each other denote an alkyl, aryl, alkylaryl, arylalkyl, alkoxyalkyl or alkoxyaryl group each with up to 18 carbon atoms, the total number of carbon atoms in R¹, R² and R³ being at the most 20;
X stands for a common counteranion X⁻, for example a halogen, acetate, phosphate, nitrate or alkylsulfate and preferably a chloride. A cationic cellulose is sold by Amerchol under the designation Polymer JR and bears the INCI designation Polyquaternium-10. Another cationic cellulose bears the INCI designation Polyquaternium-24 and is sold by Amerchol under the tradename Polymer LM-200. A suitable cationic guar derivative is sold under the tradename Jaguar® R and bears the INCI designation Guar Hydroxypropyltrimonium Chloride. Particularly preferred cation-active substances are chitosan, chitosan salts and chitosan derivatives. The chitosans are completely or partly deacetylated chitins. The molecular weight of chitosan can be spread over a wide range, for example from 20,000 to about 5 million g/mol. Suitable is, for example, a low-molecular-weight chitosan with a molecular weight of 30,000 to 70,000 g/mol. Preferably, however, the molecular weight is higher than 100,000 g/mol and most preferably 200,000 to 700,000 g/mol. The degree of deacetylation is preferably from 10 to 99% and most preferably from 60 to 99%. A preferred chitosan salt is chitosoniumpyrrolidone carboxylate sold, for example, by the Amerchol company, USA, under the tradename Kytamer® PC. The chitosan it contains has a molecular weight of about 200,000 to 300,000 g/mol and is 70 to 85% deacetylated. Suitable chitosan derivatives are the quaternized, alkylated or hydroxyalkylated derivatives, for example hydroxyethyl-, hydroxypropyl- and hydroxybutylchitosan. The chitosans and chitosan derivatives are preferably in neutralized or partly neutralized form. The degree of neutralization of chitosan or of the chitosan derivative is preferably at least 50% and most preferably between 70 and 100%, based on the number of free basic groups. In principle, all cosmetically harmless inorganic or organic acids can be used as neutralization agents, for example formic acid, malic acid, lactic acid, pyrrolidonecarboxylic acid and hydrochloric acid among others, among which pyrrolidonecarboxylic acid and lactic acid are particularly preferred.

### Carrier Medium

Suitable as the liquid carrier medium are, for example, solvents or dispersing agents, such as water, alcohols, ethers, ketones or hydrocarbons or mixtures of two or more of said substances, as long as the substances or the mixtures thereof are liquid at room temperature (25° C.). The amount of liquid carrier medium contained in the rollable composition can range from 20 to 90 wt. % or from 30 to 70 wt. %. Suitable alcohols are, in particular, the lower monohydric or polyhydric alcohols with 1 to 5 carbon atoms usually employed for cosmetic purposes, for example ethanol, isopropanol, ethylene glycol, glycerol and propylene glycols, particularly 1,2-propylene glycol.

### Additives

For further optimization, the foils can contain additives, particularly emulsifiers in an amount of up to 50 wt. %, softeners (for example glycerol, polyethylene glycols) up to 50 wt. %, or hair luster-imparting agents, particularly oils such as, for example, vegetable oils, hydrocarbon oils or silicone oils up to 30 wt. %. Moreover, the product of the invention can contain common additives in an amount typical for hair-treatment agents, namely from 0.01 to 15 wt. % of moisture-retaining substances, fragrances in an amount from 0.1 to 0.5 wt. %, preservatives in an amount from 0.01 to 1.0 wt. %, buffering substances such as, for example, sodium citrate or sodium phosphate, in an amount from 0.1 to 1.0 wt. %, tinting substances, for example fluorescein sodium salt, in an amount from about 0.1 to 1.0 wt. %, hair-care agents such as, for example, plant and herb extracts, protein hydrolyzates and silk hydrolyzates, lanolin derivatives in an amount from 0.1 to 5 wt. %, physiologically harmless silicone derivatives, for example volatile or non-volatile silicone oils or high-molecular-weight siloxane polymers, in an amount from 0.05 to 30 wt. %, light stabilizers, antioxidants, free-radical scavengers, antidandruff agents, in an amount from about 0.01 to 2 wt. %, vitamins, combability improvers, pigments and/or water-insoluble particulate solids.

A particular embodiment of the invention concerns a hair-styling foil containing at least 85 wt. % and particularly more than or 85 wt. % to 97 wt. % of at least one hair-fixing polymer and more than 3 wt. % and particularly more than 3 wt. % and less than 15 wt. % of at least one surfactant. Suitable hair-fixing polymers are the afore-said hair-fixing polymers particularly those based on polysaccharides and hair-fixing nonionic, synthetic polymers. Particularly preferred is a polymer combination of (a) pullulan and (b) at least one polymer selected from among polyvinylpyrrolidone and polyvinylpyrrolidone/vinyl acetate copolymer, the weight ratio of (a) to (b) preferably being less than 2:1 or less than 1:1 and particularly 1:10 or 1:4 to less than 1:1.

Suitable surfactants are nonionic, cationic, anionic and amphoteric surfactants. Anionic surfactants are, for example, fatty alcohol sulfates, alkyl ether sulfates and alkylbenzenesulfonates. Suitable amphoteric surfactants are, for example, betaines such as fatty amide alkylbetaines, sulfobetaines and C₈ to C₂₂ alkylbetaines. The surfactants are preferably selected from among nonionic and cationic surfactants. Particularly preferred is a surfactant combination of at least one cationic and at least one nonionic surfactant. The weight ratio of cationic to nonionic surfactants is in this case from 1:10 to 10:1, from 1:5 to 5:1 and particularly from 1:1.5 to 1.5:1.

Suitable cationic surfactants are those containing a quaternary ammonium group and that can be represented by the general formula

N⁽⁺⁾R¹R²R³R⁴X⁽⁻⁾

wherein R¹ to R⁴ independently of each other denote aliphatic groups, aromatic groups, alkoxy groups, polyoxyalkylene groups, alkylamido groups, hydroxyalkyl groups, aryl groups or alkaryl groups with 1 to 22 carbon atoms, wherein at least one of the R¹ to R⁴ groups has at least 8 carbon atoms and X⁻ denotes an anion, for example a halogen, acetate, phosphate, nitrate or alkyl sulfate and preferably a chloride. In addition to the carbon atoms and hydrogen atoms, the aliphatic groups can contain crosslinks or other groups such as, for example, additional amino groups.

Examples of suitable cationic surfactants are the chlorides or bromides of alkyldimethylbenzylammonium salts, alkyltrimethylammonium salts, for example cetyltrimethylammonium chloride or bromide, tetradecyltrimethylammonium chloride or bromide, alkyldimethylhydroxyethylammonium chlorides or bromides, dialkyldimethylammonium chlorides or bromides, alkylpyridinium salts, for example laurylpyridium chloride or cetylpyridinium chloride, alkylamidoethyltrimethylammonium ether sulfates and compounds with a cationic character, such as the amine oxides, for example alkylmethylamine oxides or alkylaminoethyldimethylamine oxides. Cetyltrimethylammonium chloride is particularly preferred.

Suitable nonionic surfactants are, for example, those listed in the “International Cosmetic Ingredient Dictionary and Handbook”, 7th edition, volume 2, in the section on “Surfactants”, for example ethoxylated fatty alcohols, ethoxylated nonylphenols, fatty acid mono- and diglycerides, ethoxylated and hydrogenated or nonhydrogenated castor oil, fatty alkanolamides, ethoxylated fatty esters, fatty acid sugar esters and alkylglucosides. Preferred surfactants are, for example:
ethoxylated fatty alcohols, fatty acids, fatty acid glycerides and alkylphenols, particularly the addition products of 2 to 30 moles of ethylene oxide and/or 1 to 5 moles of propylene oxide to C₈-C₂₂ fatty alcohols, to C₁₂-C₂₂ fatty acids or to alkylphenols with 8 to 15 carbon atoms in the alkyl group,
C₁₂-C₂₂ fatty acid monoesters and diesters of the addition products of 1 to 30 moles of ethylene oxide to glycerol,
the addition products of 5 to 60 moles and preferably 20 to 50 moles of ethylene oxide to castor oil or to hardened (hydrogenated) castor oil,
fatty acid sugar esters, particularly the esters of sucrose and one or two C₈-C₂₂ fatty acids, INCI designations: Sucrose Cocoate, Sucrose Dilaurate, Sucrose Distearate, Sucrose Laurate, Sucrose Myristate, Sucrose Oleate, Sucrose Palmitate, Sucrose Ricinoleate and Sucrose Stearate,
polyglycerol fatty acid esters, particularly those of one, two or more C₈-C₂₂ fatty acids and a polyglycerol, preferably one with 2 to 20 glyceryl units,
alkylglycosides, particularly the alkyloligoglycosides, with C₆-C₂₂ alkyl groups.

In a particular embodiment of the invention, bubbles of a suitable gas, preferably air, are enclosed in the foils. Foils with enclosed gas bubbles are characterized by particularly good dissolution properties and especially high ability to be rubbed and worked into the hair. The gas bubbles can be enclosed by a method known to be used for the production of bubbles-containing plastic materials, for example by one of the following methods:
(1) using an expanding agent or propellant (blowing agent)
(2) foaming by mechanical agitation of the carrier mixture while it is still a liquid or a viscous liquid,
(3) by a gas-generating chemical reaction,
(4) using a highly volatile solvent and evaporating said solvent at an elevated temperature,
(5) injecting a liquefied gas into the still viscous carrier mixture.

Expanding agents are chemicals which when heated decompose and form a gas, for example nitrogen, carbon dioxide, carbon monoxide, ammonia or hydrogen. Inorganic expanding agents are, for example, carbonates, hydrogen carbonates, borohydrides, silicon oxyhydrides etc. Particularly preferred are organic expanding agents such as those used to produce porous or bubble-containing plastic materials.

In a preferred embodiment of the invention, the hair-styling foil contains at least 50 wt. % of hair-fixing polymers including pullulan in combination with at least one additional hair-fixing polymer, the weight ratio of pullulan to the additional hair-fixing polymer being less than 1:1, namely the amount of pullulan used is less than the amount of the additional hair-fixing polymer. The amount of pullulan used is preferably from 15 to 45 wt. % and that of the additional hair-fixing polymer is preferably from 30 to 70 wt. %.

Combinations of pullulan with synthetic styling polymers can produce foils which because of a certain brittleness and fragility are still not fully satisfactory. This can be improved by adding a certain amount of polyols. In another preferred embodiment of the invention, the hair-styling foil therefore contains additionally at least one polyol. A polyol is an organic compound with two or more alcoholic hydroxyl groups. Suitable polyols are, for example, polyhydric alcohols preferably with up to 5 carbon atoms and particularly glycols and glycerol, moreover sugar alcohols and polyethylene glycols that are liquid at 25° C. Glycols are, for example, ethylene glycol, propylene glycol and butylene glycol. Sugar alcohols are, for example, sorbitol, mannitol, malitol and lactitol. Liquid polyethylene glycols are, for example, diethylene glycol, triethylene glycol, tetraethylene glycol etc, and preferably those with a degree of polymerization of up to about 12 and a molecular weight of up to about 600. Preferred is a combination of 50 to 97 wt. % of a hair-fixing polymer with 1 to 50 wt. % and particularly more than 5 wt. %, for example 5 to 20 wt. % or 10 to 15 wt. %, of a polyol, based on the dry, water-free foil, glycerol being particularly preferred. In particular, the presence of a polyol improves the clarity and elasticity of the foil, namely the foils do not break easily.

At higher environmental temperatures and/or higher air humidity, the risk exists that the hair-styling foils will stick to each other in the package so that it will no longer be possible to remove them from the package readily and separate from one another. This can be improved by use of appropriate release agents. Another preferred embodiment of the invention therefore relates to hair-styling foils that are treated with a powdered release agent. The preferably hydrophobic release agent adheres externally to the foil and prevents sticking of the foils to one another especially during storage or when used at high air humidity. Suitable release agents are, for example, talc, starch and modified starch. The modification of starch can be accomplished by one of the generally known methods including physical, chemical or enzymatic modifications. Physical modifications are, for example heat treatments or treatment with shearing forces. Chemical modifications are, for example, crosslinking, acetylation, esterification, hydroxyethylation, hydroxypropylation, phosphorylation and the use of succinates and substituted succinates. Preferred are modified starches with the INCI designations Aluminum Starch Octenylsuccinates and Corn Starch Modified. The release agent is applied to the finished, dried foils. Typical application quantities are about 0.01 to 0.1 g and preferably 0.02 to 0.05 g per foil with dimensions of 4×4 cm and a thickness of up to 0.5 mm.

Foils treated with a release agent are characterized by improved nonstickiness so that even after several weeks they can readily be removed from the package without sticking to one another. At the same time, unexpectedly, the release agents do not leave any visible residues on the hair after the foil has been used for hair-styling as directed.

### Use

The foils can be packaged in very compact, space-saving manner, for example in the form of a roll or as pads stacked on top of each other. The foils can be rubbed with wet or moist hands. The completely or partly dissolved foil can then be applied to dry or moist hair after which the hair can be styled into a hairdo in the same manner as when a conventional styling gel is used. The foils can also be applied directly to wet or moist hair and manually worked into the hair.

The following examples will explain the subject matter of the invention in greater detail.

### EXAMPLES

### Example 1

### Rollable Composition

| | | |
|---|---|---|
| 45 | g | of polyvinylpyrrolidone (Luviskol ® K90) |
| 5 | g | of Rewoteric ® AM CAS (cocamidopropyl |
| | | hydroxysultain, 50% in water) |
| 0.25 | g | of perfume |
| to 100 | g | ethanol |

### Example 2

### Styling Foil

| | | |
|---|---|---|
| 42.5 | g | of polyvinylpyrrolidone (Luviskol ® K90) |
| 42.0 | g | of pullulan |
| 7.5 | g | of cetyltrimethylammonium chloride |
| 7.5 | g | of PEG-40 hydrogenated castor oil |
| 0.5 | g | of perfume |

### Example 3

### Styling Foils

| | | |
|---|---|---|
| A | B | C |

| | | | | | | |
|---|---|---|---|---|---|---|
| Pullulan | 29.85 | g | 59.7 | g | 42.29 | g |
| PVP (Luviskol K90) | 59.7 | g | 29.85 | g | 42.29 | g |
| Cetyltrimethylammo- | 4.98 | g | 4.98 | g | 7.46 | g |
| nium chloride | | | | | | |
| PEG-40 Hydrogenated | 4.98 | g | 4.98 | g | 7.46 | g |
| Castor Oil | | | | | | |
| Perfume | 0.5 | g | 0.5 | g | 0.5 | g |

From compositions A, B and C, rollable doughs were prepared with water as solvent. Foils were prepared by rolling the doughs, and the foils were then dried.

The foils were judged on the basis of the following criteria:
(a) Dissolution properties when rubbed manually with a small amount of water:
   very good: ++; good: +; sufficient: 0; poor: −
(b) Foaming when worked into the hair:
   does not foam: +; foams: −
(c) Stickiness:
   good stickiness: +; poor stickiness: −
(d) Coagulation characteristics when worked into the hair:
   does not coagulate, no formation of visible residues: +coagulates, visible residues: −
(e) Fixing properties:
   good hair fixing: +; weak hair fixing: 0; no hair fixing: −

| | A | B | C |
|---|---|---|---|
| Solubility | ++ | ++ | + |
| Foaming | + | + | + |
| Stickiness | + | + | |
| Coagulation | + | − | + |
| Fixing | + | + | 0 |

### Example 4

### Glycerol-Containing Styling Foil

| | A | B | C |
|---|---|---|---|
| Pullulan | 28.44 | 27.15 | 25.97 |
| PVP (Luviskol K90) | 56.87 | 54.3 | 51.95 |
| Cetyltrimethylammonium | 4.74 | 4.52 | 4.33 |
| chloride | | | |
| PEG-40 Hydrogenated | 4.74 | 4.52 | 4.33 |
| Castor Oil | | | |
| Perfume | 0.47 | 0.45 | 0.43 |
| Glycerol, 86% | 4.74 | 9.05 | 12.99 |
| | D | E | F |
| Pullulan | 24.9 | 23.9 | 22.99 |
| PVP (Luviskol K90) | 49.79 | 47.81 | 45.98 |
| Cetyltrimethylammonium | 4.15 | 3.98 | 3.83 |
| chloride | | | |
| PEG-40 Hydrogenated | 4.15 | 3.98 | 3.83 |
| Castor Oil | | | |
| Perfume | 0.41 | 0.4 | 0.38 |
| Glycerol, 86% | 16.6 | 19.92 | 22.99 |

### Example 5

### Compositions for Preparing Styling Foils With and Without Glycerol

| | A | B |
|---|---|---|
| Pullulan | 3 | 3 |
| PVP (Luviskol K90) | 6 | 6 |
| PVP (Luviskol K30) | 2 | 2 |
| Cetyltrimethylammonium chloride | 0.5 | 0.5 |
| PEG-40 Hydrogenated Castor Oil | 0.5 | 0.5 |
| Perfume | 0.05 | 0.05 |
| Glycerol. 86% | 2.2 | — |
| Water | to 100 | to 100 |

The hair-styling foils obtained from composition A were very elastic and were easy to apply, namely they dissolved readily by using a small amount of water in the hand and they were easy to work into the hair. The foils prepared from composition B, on the other hand, were more brittle, more friable and less readily applied.

### Example 6

### Styling Foils Treated With a Release Agent

| | A | B | C |
|---|---|---|---|
| Pullulan | 21.05 | 21.05 | 21.05 |
| PVP (Luviskol K90) | 42.11 | 42.11 | 42.11 |
| PVP (Luviskol K30) | 14.04 | 14.04 | 14.04 |
| Cetyltrimethylammonium chloride | 3.51 | 3.51 | 3.51 |
| PEG-40 Hydrogenated Castor Oil | 3.51 | 3.51 | 3.51 |
| Perfume | 0.35 | 0.35 | 0.35 |
| Glycerol, 86% | 15.44 | 15.44 | 15.44 |
| Post-treatment with Dry Flo Plus⁽¹⁾ | 0.03 g/foil | — | — |
| Post-treatment with Dry Flo PC⁽²⁾ | — | 0.03 g/foil | — |
| Post-treatment with Dry Flo AF⁽³⁾ | — | — | 0.03 g/foil |

⁽¹⁾Aluminum Starch Octenylsuccinates; hydrophobic starch
⁽²⁾Aluminum Starch Octenylsuccinates; hydrophobic starch
⁽³⁾Corn Starch Modified; hydrophobic starch; Ca salt of the ester obtained by reaction of 3-(dodecenyl)dihydro-2,5-furanedione with corn starch.

Foils 4×4 mm in size were prepared and each was treated with 0.03 g of post-treatment agent. None of the foils were sticky and they were easily separated from each other. Analogous foils that were not post-treated, on the other hand, stuck to each other after they were stored for a while and could no longer be readily separated from one another.

1. Method for producing a hair-fixing product in the form of a foil whereby
first a rollable composition is prepared by dissolving or dispersing a polymer in a liquid carrier medium and
then by means of a rolling device the composition is rolled into foil shape and
at the same time or subsequently the liquid carrier medium is evaporated.

2. Method as defined in claim 1, characterized in that the polymer is a foil-forming and/or hair-fixing polymer.

3. Method as defined in claim 1, characterized in that the liquid carrier medium is selected from among water, alcohols, ethers, ketones and hydrocarbons and mixtures of said substances, provided that the substance or mixture of substances is liquid at room temperature (25 θC).

4. Method as defined in claim 1, characterized in that the rollable composition contains the polymer in an amount from 10 to 80 wt. % and the liquid carrier medium in an amount from 20 to 90 wt. %.

5. Method as defined in claim 1, characterized in that after evaporation of the liquid carrier medium the amount of polymer in the foil is from 50 to 97 wt. %.

6. Method as defined in claim 1, characterized in that the composition contains at least one water-soluble polymer.

7. Method as defined in claim 1, characterized in that the composition contains pullulan.

8. Method as defined in claim 7, characterized in that the pullulan has an average molecular weight from 10,000 to 5,000,000.

9. Method as defined in claim 7, characterized in that the composition contains at least one additional hair-fixing polymer.

10. Method as defined in claim 9, characterized in that the weight ratio of pullulan to the additional hair-fixing polymer is from 1:10 to 10:1.

11. Method as defined in claim 10, characterized in that the additional hair-fixing polymer is selected
from among polymers derived from at least one monomer selected from among vinyllactams, vinyl esters, vinyl alcohols, acrylamides, methacrylamides, alkylacrylamides, dialkylacrylamides, alkylmethacrylamides, dialkylmethacrylamides, dialkylaminoalkylmethacrylamides, dialkylaminoalkylacrylamides, alkyl acrylates, alkyl methacrylates, propylene glycol and ethylene glycol;
from among polymers derived from at least one monomer selected from among acrylic acid, methacrylic acid, crotonic acid, maleic acid, maleic anhydride and monoesters of maleic acid;
from among polymers derived from at least one monomer selected from among trialkylmethacryloxyalkylammonium, trialkylacryloxyalkylammonium, dialkyldiallylammonium, alkylvinylimidazolium, alkylvinylpyridinium and alkylvinylpyrrolidone;
from among polymers derived from at least one kind of monomer containing acid groups and from at least one other kind of monomer containing basic amino groups;
from among polymers derived from at least one kind of monomer containing both quaternary amino groups and acid groups or from polymers derived from at least one first kind of monomer containing quaternary amino groups and at least one second kind of monomer containing acid groups.

12. Method as defined in claim 11, characterized in that the additional polymer is selected from among polyvinylpyrrolidone, polyvinylcaprolactam, polyacrylamides, vinylpyrrolidone/vinyl acetate copolymer, crosslinked and uncrosslinked vinyl acetate/-crotonic acid copolymers, terpolymers of vinylpyrrolidone, vinyl acetate and vinyl alkanoate, terpolymers of vinyl acetate, crotonate and vinyl alkanoate, partly esterified copolymers of vinyl methyl ether and maleic anhydride, copolymers of acrylic acid and/or methacrylic acid and alkyl acrylates, alkyl methacrylates, N-alkylacrylamides, N-alkyl-methacrylamides, and/or polystyrene sulfonates, copolymers of alkylacrylamide, alkylaminoalkyl methacrylate and two or more monomers selected from among acrylic acid, methacrylic acid or the C₁ to C₄ alkyl esters thereof, with at least one of the monomers containing an acid group; copolymers of acrylic acid, methacrylate and methacrylamido-propyltrimethylammonium chloride, copolymers of acrylamidopropyltrimethylammonium chloride and acrylates, copolymers of acrylamide, acrylamidopropyltrimethylammonium chloride, 2-amidopropylacrylamido sulfonate and dimethylaminopropylamine, copolymers of methacryloylethylbetaine and two or more monomers selected from among acrylic acid or the simple esters thereof, methylvinylimidazolium chloride/vinylpyrrolidone copolymers, polyvinylpyrrolidone/dialkylaminoalkyl methacrylate copolymers, quaternized vinylpyrrolidone/dialkylaminoalkyl methacrylate copolymers, homopolymers of dimethyldiallylammonium chloride, copolymers of dimethyldiallylammonium chloride and at least one other monomer, quaternized hydroxyethylcellulose or quaternized guar derivatives, terpolymers of vinylpyrrolidone, vinylcaprolactam and a basic acrylamide monomer or methacrylamide monomer and vinylpyrrolidone/methacrylamidoalkyltrimethylammonium chloride copolymers.

13. Method as defined in claim 1, characterized in that the foil additionally contains at least one substance selected from among emulsifiers, softeners, hair luster-imparting agents, preservatives, fragrances, pigments, product tinting agents and water-insoluble particulate solids.

14. Method as defined in claim 1, characterized in that the thickness of the foil after rolling is less than 0.5 mm.

15. Method as defined in one of the preceding claims, characterized in that gas bubbles are introduced into the foil.

16. Hair-styling foil made by a method as defined in claim 1.

17. Hair-styling foil containing at least 85 wt. % of at least one hair-fixing polymer and more than 3 wt. % of at least one surfactant.

18. Hair-styling foil as defined in claim 17, characterized in that the hair-fixing polymer is selected from among polysaccharide-based polymers and nonionic synthetic polymers.

19. Hair-styling foil as defined in claim 18, characterized in that it contains as the hair-fixing polymer a combination of (a) pullulan and (b) at least one polymer selected from among polyvinylpyrrolidone and polyvinylpyrrolidone/vinyl acetate copolymer, the weight ratio of (a) to (b) being less than 1:1.

20. Hair-styling foil as defined in claim 17, characterized in that the surfactant used is a mixture of at least one cationic and at least one nonionic surfactant, the weight ratio of the cationic to the nonionic surfactant being 1:10 to 10:1.

21. Hair-styling foil containing at least 50 wt. % of hair-fixing polymers and containing pullulan in combination with at least one additional hair-fixing polymer, the weight ratio of pullulan to the additional hair-fixing polymer being less than 1:1.

22. Hair-styling foil as defined in claim 21, characterized in that it contains pullulan in an amount from 15 to 45 wt. % and the additional hair-fixing polymer in an amount from 30 to 70 wt. %, provided that the weight ratio of pullulan to the additional hair-fixing polymer is less than 1:1.

23. Hair-styling foil as defined in claim 17, characterized in that the foil thickness is less than 0.5 mm.

24. Hair-styling foil as defined in claim 17, characterized in that it contains enclosed air bubbles.

25. Hair-styling foil as defined in claim 17, characterized in that additionally it contains at least one polyol.

26. Hair-styling foil as defined in claim 25, characterized in that it contains the polyols in an amount from 1 to 50 wt. % and that said polyols are selected from among glycols, glycerols, sugar alcohols and polyethylene glycols that are liquid at 25 νC.

27. Hair-styling foil containing at least 50 wt. % of hair-fixing polymers, characterized in that the foil is treated with a powdered release agent adhering to the foil.
